(19) United States
(12) Patent Application Publication
(10) Pub. No.: US 2006/0274718 A1
(43) Pub. Date: Dec. 7, 2006

(54) Inter-domain multipath routing method

(76) Inventors: Stefan Butenweg, Munchen (DE); Claus Gruber, Munchen (DE); Thomas Schwabe, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/566,779

(22) PCT Filed: Jul. 29, 2004
(86) PCT No.: PCT/EP04/51662

§ 371 Date: Aug. 14, 2006

(30) Foreign Application Priority Data
Aug. 1, 2003 (EP) 103 35 335.6

(51) Int. Cl. H04L 12/28; H04L 12/56

(52) U.S. Cl. 370/351; 370/401

(57) ABSTRACT

An inter-domain multipath routing method, for extending multipath routing beyond the limits of packet-oriented networks or autonomous systems is provided. A traffic distribution over several links, outgoing from a packet-oriented network with multipath routing, is carried out. For the determination of alternative paths, leading to neighboring networks, the edge nodes of neighboring networks, by means of which a target can be reached, can be combined as a virtual end point. The virtual edge nodes then permit alternative paths between a starting point and the virtual end point to be determined by means of conventional methods, for example, multipath MPLS. Packets are then distributed over the paths, whereby a distribution beyond the network limit is also induced.

### CROSS REFERENCE TO RELATED APPLICATIONS

This application is the US National Stage of International Application No. PCT/EP2004/051662, filed Jul. 29, 2004 and claims the benefit thereof. The International Application claims the benefits of German application No. 10335335.6 DE filed Aug. 1, 2003, both of the applications are incorporated by reference herein in their entirety.

### FIELD OF INVENTION

The invention relates to a method for optimized inter-domain routing between packet-oriented networks and a method for determining paths for multipath routing in a packet-oriented network, including the distribution of packets over a plurality of links connecting different packet-oriented networks.

### BACKGROUND OF INVENTION

Arguably one of the currently most important developments in the area of networks is the improvement of packet-oriented networks in respect of functions for routing real-time traffic such as voice traffic or video transmissions.

The majority of the protocol stacks for routing data packets use the Internet Protocol, mainly abbreviated to IP protocol in the technical literature, on what is referred to as the network layer. The IP protocol allows data to be switched via various, in some cases technically different, networks. The IP protocol on the network layer provides routing information which can be interpreted by all the networks involved in routing. The most important information of this kind is address information.

In the context of the IP concept, individual networks with a uniform routing technology are also known as routing domains, autonomous systems or sub-networks. In the following, the term network will be used to denote a network within which uniform routing mechanisms are used, and not a network of networks.

A network is generally organized by a network operator having certain freedoms in respect of the routing mechanisms used. Within IP networks, the OSPF (open shortest path first) protocol is normally used for routing. The OSPF protocol is what is termed a linked state protocol whereby routing tables are established or adapted to provide optimum routing by means of the exchange of topology information between the routers or nodes.

For routing within packet-oriented networks there are methods based on the conventional protocols for improved routing in respect of compliance with quality of service features which are essential for real-time traffic.

One approach is by means of the MPLS (multiprotocol label switching) method. As part of this method, paths are defined by the network. The path through the network is specified and the corresponding packets are identified by labels or information fields according to the destination to which the traffic is to be forwarded or according to the address information contained in the packets. The labels then determine the routing onto a path through the network. A refinement of the MPLS concept is provided by multipath routing whereby traffic is transmitted via several MPLS paths to an edge node of the network (multipath MPLS). Another concept, the ECMP (equal cost multipath) method, involves the distribution of traffic over equivalent paths in terms of a metric or cost function.

Another approach for improving routing within a network (intra-domain routing) is being developed as part of the KING (Key components for the mobile Internet of Next Generation) project. The aim of this concept is to avoid the complexity of the MPLS method while nevertheless allowing routing with maintenance of quality of service features. With MPLS, states must be defined or retained network-wide. The routing or, in the case of multipath MPLS routing, the distribution of packets is specified on entry to the network. Information about the paths used and their capacity utilizations must be held and evaluated centrally in order to enable the bandwidth to be used so as to maintain quality of service features. In the KING project, the information required centrally or at the edge of the network is greatly reduced by essentially keeping the locality of the routing decisions as in the conventional IP network. Critical aspects of the concept are:
traffic controls at network entrance and exit
transmission of traffic from an entry point to an exit point along multiple paths (multipath routing)
distribution over different paths and re-distribution in the event of disturbances by means of local routing decisions

The idea behind the concept is that only the aggregated traffic volumes are controlled at the network boundaries. Distribution within the network is ensured by suitable local measures designed to prevent bottlenecks.

As well as optimized routing within the networks involved, routing between the networks is crucial for efficient global data transmission. Data is currently transmitted between IP networks (inter-domain routing) by means of BGPs (border gateway protocols). In the case of the BGP protocol, the edge nodes of neighboring networks exchange reachability data with respect to other known networks. In general this information includes vectors of the identification codes of networks to be traversed to reach a destination network. Using this data, the edge nodes ascertain all the permissible paths to other networks and compare these with one another. Preferred paths are selected according to specified criteria, such as minimum number of networks to be traversed.

Routing between the networks represents a sensitive point for the forwarding of traffic:
The connection between two networks is a potential bottleneck at which no adequate bandwidth control is generally provided. As different networks are mainly operated by different independent companies, in general the topology information is not completely exchanged and mechanisms which are used within networks for traffic control are generally unavailable.
The connection of two networks constitutes a critical point in respect of disturbances and failures of network elements. The BGP protocol provides for the propagation of adapted topology information to the individual networks for recalculation of the inter-domain routing in the event of failures. This method frequently converges poorly and is in any case too slow to avoid impairment of the transmission of real-time traffic.

Packets are transmitted between networks or domains by means of routers which support a BGP (border gateway protocol). The packets are transmitted from a BGP instance or BGP router to a BGP instance in another network. The term edge node will now be used for routers or nodes which can communicate with nodes in other networks. Edge nodes then generally support a BGP protocol. (BGP protocol is both a generic term and a protocol name).

### SUMMARY OF INVENTION

An object of the invention is to specify methods which help to optimize routing between packet-oriented networks (inter-domain routing).

This object is achieved by the subject matter of the independent claims.

The basis of the invention is that multipath routing methods are extended to the area between networks (inter-domain routing). For this purpose packets sent from a packet-oriented network to a destination are distributed over a plurality of links (e.g. 2) leading away from the network.

Conventional multipath methods such as multipath MPLS or the KING concept for widening multipath routing to include inter-domain links (i.e. links connecting networks) can be extended to the intermediate area between packet-oriented networks as follows: The conventional methods generally define alternative paths between a start point and an end point (usually an entry or exit router of a network). According to the invention, an edge node of a neighboring network to which two or more links lead can be used as the end point for multipath determination. In this way a plurality of links connecting the network to the neighboring network are included in the determination of alternative paths, i.e. traffic can be distributed over a plurality of inter-domain links.

Alternatively, to define the paths and/or the distribution weightings, a plurality of neighboring edge routers of networks via which the destination can be reached can also be combined to form a virtual end point or can be regarded as a virtual node. The defining of alternative paths then takes place between a node of the network and this virtual end point. The advantage of this approach is that traffic can be distributed over different edge routers of one or more neighboring networks, thereby reducing the effects of disturbances due to router failure.

By means of the conventional methods such as multipath MPLS or multipath routing within the scope of the KING concept, different paths can be specified which extend from a start point within the network to the (virtual) end point outside the network, thereby defining inter-domain multipath routing between the network of the start point and the network or networks in which the edge nodes constituting the virtual end point are located, it being possible to use the method according to the invention along a route through a plurality of networks, thereby allowing multipath routing along this route encompassing a plurality of networks, the individual networks being able to support different multipath routing methods (e.g. multipath MPLS, KING, ECMP).

According to a development, a plurality of edge nodes of the network exist through which traffic to be forwarded to the destination is transmitted via links to other networks. The packets forwarded to the destination can then be distributed over the edge nodes.

Distributing the traffic over a plurality of paths reduces overloading of the inter-domain connections and adjacent routers and increases the availability of end-to-end connections.

The extended multipath concept presented here has various advantages:

A) Less overloading of border routers or edge nodes and intra-domain connections (i.e. connections of different networks)

The extended multipath concept presented here enables traffic to be evenly distributed throughout the network and beyond domain boundaries, thereby enabling overloading of individual connections and the components bordering the domains (inter-domain connections and border routers) to be reduced or prevented.

B) Significant speeding-up of the convergence time in the event of border gateway (e.g. border router or edge node) failures.

When using conventional concepts, in the event of failure of a border router or its intra-domain connection, another border router is used to maintain the traffic flow. The routing tables of the autonomous system must be adapted to the new path. During reconfiguration of the routing tables, routing loops may arise in the network, packets are delayed by frequent changes to the routing tables, diverted onto longer paths, out of order or even lost.

Using the proposed concept, no global reconfiguration (e.g. BGP followed by OSPF re-routing) is necessary. When failure of a border element is detected, a quickly executable local reaction (e.g. re-distribution of traffic) is sufficient to rectify the problem. The packets are automatically forwarded to the nearest border router e.g. analogously to intra-domain routing.

C) Reduced complexity through using known concepts

To specify the paths for multipath routing beyond network boundaries, the edge nodes of the adjacent networks via which the destination is reachable and via which traffic is to be routed to the destination are combined to form a virtual point. Conventional methods for determining alternative paths between a start and end point can then be applied. Routing mechanisms based on multipath routing, e.g. for responding to faults or disturbances, can likewise be used. By using known and tested algorithms and protocol parts of multipath MPLS, ECMP or KING, the complexity, implementation cost and fault proneness of the new inter-domain multipath concept is greatly reduced.

### BRIEF DESCRIPTION OF THE DRAWINGS

The invention will now be described in greater detail with reference to an exemplary embodiment and the accompanying drawings, in which:

FIG. 1: illustrates routing as part of the KING concept

FIG. 2: illustrates routing as part of the MPLS concept

FIG. 3: shows the dual homing concept

FIG. 4: shows the redundant dual homing concept

FIG. 5: shows the linking of a destination domain through different transit domains

FIG. 6: illustrates the splitting of traffic and re-aggregation at an edge router using the multipath MPLS concept as an example

FIG. 7: shows the selection of suitable edge nodes as gateways for the destination domain

FIG. 8: shows the combining of the gateways from FIG. 7 to form a virtual router

FIG. 9: illustrates the incorporation of a virtual router into known intra-domain routing concepts in the case of the multipath MPLS concept

FIG. 10: shows the configuration of the traversed routers of the network on the basis of known routing concepts

### DETAILED DESCRIPTION OF INVENTION

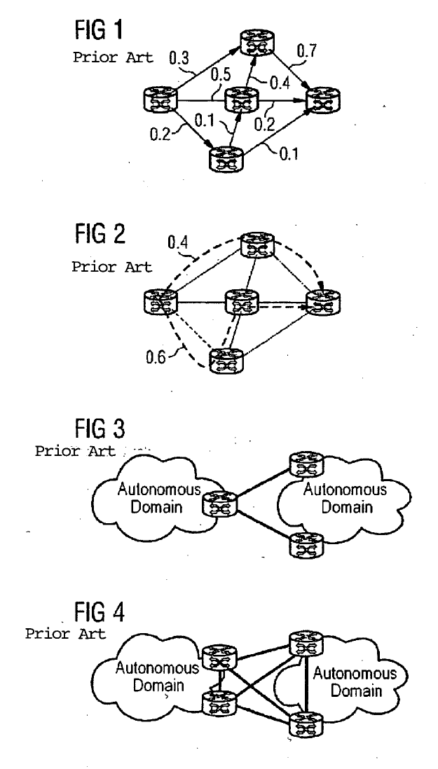

FIGS. 1 to 6 serve to illustrate the prior art and its attendant difficulties.

Newer versions and developments of the inter-domain routing protocols such as OSPF allow traffic to be distributed simultaneously over a plurality of alternative paths within a domain. Examples of this are shown for the KING concept in FIG. 1 and for the MPLS concept in FIG. 2.

As part of the KING concept (FIG. 1), traffic is split locally at each router among so-called distribution compartments, i.e. alternative outgoing links from each node to a destination, the arrows shown in FIG. 1 specifying the distribution compartments. Splitting ratios are given by way of example.

In contrast, with the MPLS concept (FIG. 2) splitting takes place at the entry node. The traffic is distributed over two alternative (MPLS) paths. A possible splitting ratio is again given.

To protect against failure of a connection between two adjacent autonomous systems, so-called dual homing concepts are used. Dual homing means using two or more possible connections between autonomous systems (FIG. 3). In the case of crosswise implemented connections, the term redundant dual homing is used (FIG. 4).

In highly meshed networks it is also possible to reach destination networks or destination domains via various transit networks (FIG. 5). Even in the event of failure of the routing functions of a transit network, a destination network is still reachable by this means, thereby enabling expensive and complex redundancy structures of edge nodes or border routers to be eliminated. Conventionally one path is used. The path shown in FIG. 5 is stored, for example, as a standby path and is put into operation when the first path is reported to have failed.

With the existing concepts such as multipath MPLS (FIG. 2) and the KING concept (FIG. 1), traffic is split among a plurality of paths within a network and re-aggregated at the selected edge node or border gateway router.

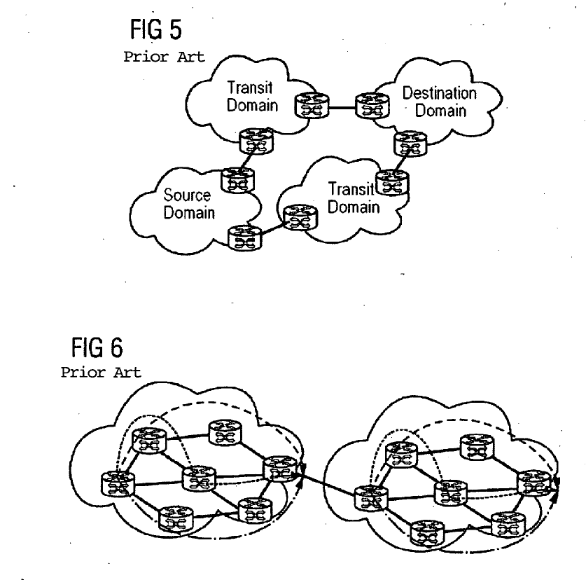

Possible overloading of the connections between the networks (inter-domain connection) and of the edge nodes used considerably reduces the throughput of the network in the direction of a remote destination address as well as its availability. FIG. 6 shows, for two MPLS networks with multipath routing, that a potential bottleneck or weakness exists between the networks. There is a risk of overloading the inter-network connection.

According to the invention, the idea of simultaneously using a plurality of paths (multipath) is extended beyond the network boundaries or domain boundaries.

The traffic leaves the autonomous system if possible on a plurality of alternative links or paths simultaneously. The number of links on which traffic to one or more networks is forwarded to a destination can be two or more.

The proposed concept will now be described in greater detail:

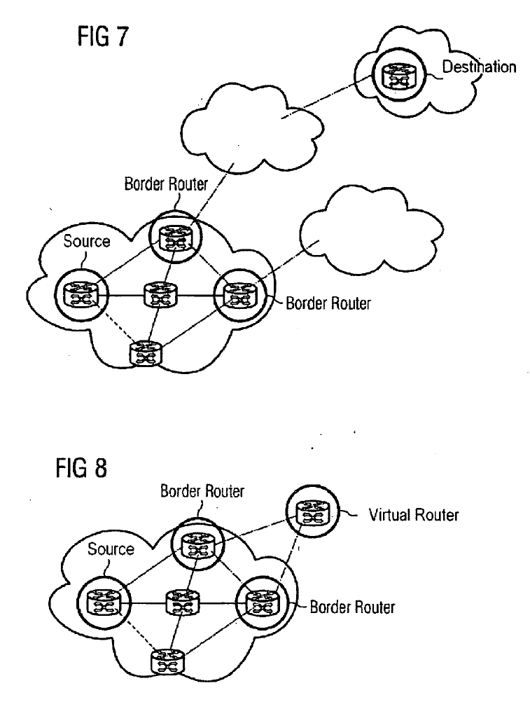

To calculate the possible paths and the traffic distribution weightings, the edge routers or border gateway routers of the adjacent domains leading to a destination are combined to form a virtual router. This is illustrated more precisely in FIGS. 7 and 8. FIG. 7 shows two edge nodes (border routers) via which packets coming from a source on different paths can be forwarded to a destination. To calculate paths and distribution weightings within the network, the view shown in FIG. 8 is used. The edge routers of neighboring networks which are reachable from the edge routers of the network for transmission to the destination are combined to form a virtual router. This has advantages when using conventional methods. Both of them, the KING concept (FIG. 1) and the MPLS multipath concept (FIG. 2), provide alternative paths between a start point and an end point. Conventionally, the start and end point are determined by the network's entry router and exit router used for routing to the destination. Within the scope of the invention, the end point for calculating alternative paths can be extended beyond the network boundary. By combining the neighboring edge nodes lying in other networks to form a virtual node, the existing concepts (which are based on an end point) can be applied without complex and costly modifications of the protocols to the situation according to the invention with extension of multipath routing to the area between the networks.

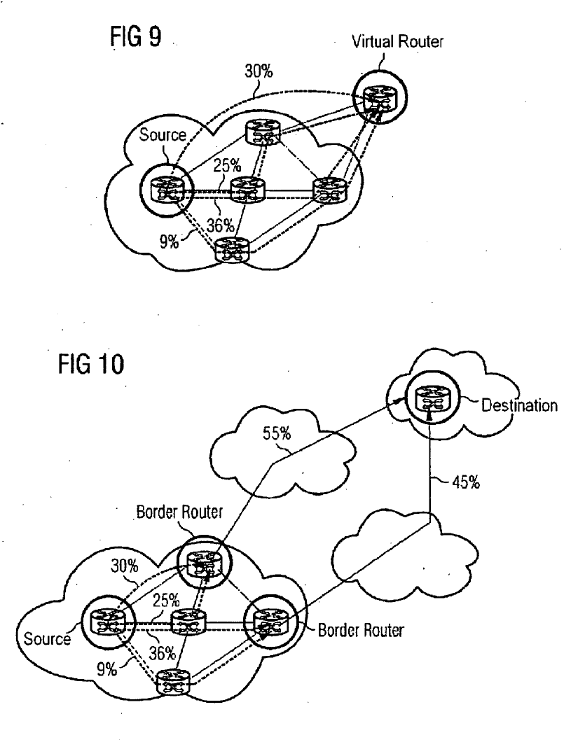

This is shown in greater detail in FIG. 9. Between a source or a start point and an end point constituted by the virtual router, various MPLS paths and associated distribution weightings or splitting ratios are specified as part of the multipath MPLS concept. This means that incorporating the resulting virtual routers into the intra-domain routing concept allows the known, tried and tested algorithms and methods to be used.

FIG. 10 shows a scenario corresponding to FIG. 9, not as in FIG. 9 from the point of view of specifying MPLS paths, but from the point of view of configuring the edge routers. The two edge routers are configured such that the incoming traffic is sent to the destination on the outgoing links in the destination direction. In the example in FIG. 10 there are two paths from the network to the destination via any transit networks over which the traffic to be routed to the destination is distributed. Two of the four MPLS paths shown in FIG. 9 coincide on these two paths in each case, which involves a corresponding accumulation of traffic outside the network. The individual routers within the network including the edge routers can be configured in accordance with the conventionally used intra-domain routing methods. The individual edge routers do not therefore see a virtual router, but the edge routers of the neighboring networks to which packets are forwarded according to the routing tables.

1-8. (canceled)

9. A method for inter-domain routing between packet-oriented communications networks, comprising:
distributing communications traffic over a plurality of inter-domain links by a first node of a first packet-oriented network, the traffic to be transmitted to a destination outside of the first network; and
calculating an alternative path between the network and a second packet-oriented network via a first node of the first network,
wherein the calculation is used by the first node and a edge node of the second network which is reachable via at least a portion of the inter-domain links,
wherein the inter-domain links connect the first network to the network in which the traffic is forwarded to the destination.

10. A method for determining paths for multipath routing between a first packet-oriented communications network and a plurality of further packet-oriented communications networks, comprising:
distributing packets over a plurality of links, each of the links connecting the first network to one of the further networks via a further node of the respective further network;
calculating the paths for routing to a destination outside the first packet-oriented network by combining the further nodes capable of routing to the destination to form a single virtual node; and
calculating a distribution weighting for routing to the destination by using the single virtual node.

11. The method according to claim 10, further comprising:
specifying a plurality of nodes of the first network from which the traffic can be forwarded to the destination, and
splitting traffic within the first network among the specified nodes.

12. The method according to claim 11, wherein splitting is performed by distributing of paths within the network.

13. The method according to claim 11, wherein splitting is performed by distributing the traffic over different Multiprotocol Label Switching paths leading to the selected nodes.

14. The method according to claim 12, wherein splitting is performed by distributing the traffic over different Multiprotocol Label Switching paths leading to the selected nodes.

15. The method according to claim 11, wherein a service affecting event of the links causes a re-distribution of traffic over the links to counteract the event.
